(19) United States
(12) Patent Application Publication
(10) Pub. No.: US 2008/0253948 A1
(43) Pub. Date: Oct. 16, 2008

(54) METHOD FOR THE RECYCLING AND PURIFICATION OF AN INORGANIC METALLIC PRECURSOR

(76) Inventors: Julien GATINEAU, Ibaraki (JP); Christian Dussarrat, Wilmington, DE (US)

Correspondence Address: AIR LIQUIDE;Intellectual Property, 2700 POST OAK BOULEVARD, SUITE 1800, HOUSTON, TX, 77056, US

(21) Appl. No.: 12/098,932

(22) Filed: Apr. 7, 2008

Related U.S. Application Data
(60) Provisional application No. 60/910,572, filed on Apr. 6, 2007.

(51) Int. Cl. C01G 55/00; B01J 19/00

(52) U.S. Cl. 423/22; 422/198

(57) ABSTRACT

Methods and apparatus for the recycling and purification of an inorganic metallic precursor. A first gaseous stream containing ruthenium tetroxide is provided, and transformed into a solid phase lower ruthenium oxide. This lower phase ruthenium oxide is reduced with hydrogen to form ruthenium metal. The ruthenium metal is contacted with an oxidizing mixture to produce a stream containing ruthenium tetroxide, and any remaining oxidizing compounds are removed from this stream through a distillation.

### CROSS REFERENCE TO RELATED APPLICATIONS

The present application claims the benefit of U.S. Provisional Application Ser. No. 60/910,572, filed Apr. 6, 2007, herein incorporated by reference in its entirety for all purposes.

### BACKGROUND

1. Field of the Invention

This invention relates generally to the field of semiconductor fabrication. More specifically, the invention relates to a method of recycling a waste stream from a semiconductor manufacturing process which contains ruthenium tetroxide.

2. Background of the Invention

Ruthenium and ruthenium compounds such as ruthenium oxide are materials considered to be promising for use as capacitor electrode materials in the next generation DRAMs. High dielectric constant materials (aka high-k materials) such as alumina, tantalum pentoxide, hafnium oxide, and barium-strontium titanate (BST) are currently used for these capacitor electrodes. These high-k materials, however, are produced using temperatures as high as 600° C., which results in oxidation of polysilicon, silicon, and aluminum and causes a loss of capacitance. Both ruthenium and ruthenium oxide, on the other hand, exhibit a high oxidation resistance and high conductivity and are suitable for application as capacitor electrode materials. They also function effectively as oxygen diffusion barriers. Ruthenium has also been proposed for the gate metal for lanthanide oxides. In addition, ruthenium is more easily etched by ozone and by a plasma using oxygen than are platinum and other noble metal compounds. The use of ruthenium as a barrier layer separating low-k material from plated copper and as a seed layer has also been attracting attention recently.

High-quality films of ruthenium and ruthenium oxide (RuO₂) can be deposited under appropriate conditions from a precursor of high-purity ruthenium tetroxide (RuO₄). This precursor can also be used for the deposition (film formation) of perovskite-type materials, such as strontium ruthenium oxide, that exhibit an excellent conductivity and a three-dimensional structure very similar to that of barium-strontium titanate and strontium titanium oxide.

When ruthenium tetroxide is used as a precursor in semiconductor manufacturing processes, it is sometimes necessary to trap and/or purify any ruthenium tetroxide left by or exhausted by the process. One method to capture ruthenium tetroxide is to use rubber (either natural, chloroprene or silicon type) to collect the ruthenium tetroxide at room temperatures. When the ruthenium tetroxide contacts the organic type material, it is transformed into ruthenium dioxide, but it is not possible to then use it again. It may also be possible to capture left over ruthenium with a silica-alumina gel, but this also introduces some difficulties in releasing the ruthenium for later re-use.

Some methods exist to purify ruthenium, but these generally require the addition of additional process chemicals (such as sodium, hydrochloric acid, halogens, or other inorganic acids) which then must be disposed of, and which can cause a concern from a health, safety and environmental perspective.

Consequently, there exists a need for a method and apparatus to recycle and purify ruthenium tetroxide which has been used in as semiconductor manufacturing process, and which does not create many hazardous byproducts which must then be disposed of.

### BRIEF SUMMARY

The invention provides novel methods and apparatus for recycling and purifying an inorganic metallic precursor, namely ruthenium tetroxide.

In an embodiment, a method to recycle and purify an inorganic metallic precursor comprises providing a first gaseous stream which comprises ruthenium tetroxide. At least part of the first stream is transformed into a solid phase lower ruthenium oxide. Ruthenium metal is then produced by transforming at least part of the lower ruthenium oxide into ruthenium metal through a reduction of the lower ruthenium oxide with hydrogen gas. The ruthenium metal is then contacted with an oxidizing mixture to produce a second stream comprising ruthenium tetroxide. This second stream is purified of any remaining oxidizing compounds to obtain a high purity ruthenium tetroxide.

In an embodiment, a method to recycle and purify an inorganic metallic precursor received from a semiconductor processing tool comprises receiving a first gaseous stream comprising ruthenium tetroxide from the output of a semiconductor manufacturing process. At least part of the first stream is transformed into a solid phase lower ruthenium oxide by heating the first stream in a heated vessel which is maintained at a temperature between about 50 and 300° C. Ruthenium metal is then produced by transforming at least part of the lower ruthenium oxide into ruthenium metal though a reduction of the lower ruthenium oxide with hydrogen gas. The ruthenium metal is then contacted with an oxidizing mixture to produce a second stream comprising ruthenium tetroxide. The second stream is purified of any remaining oxidizing compounds to obtain a high purity ruthenium tetroxide which has a purity of about 99.9%. The high purity ruthenium tetroxide is then provided to a semiconductor processing tool for use in a deposition process.

In an embodiment, an apparatus for the recycling and purification of an inorganic metallic precursor used in the manufacture of semiconductor devices comprises an inlet to receive an incoming stream containing at least one inorganic metallic precursor. At least one heated suitable to receive the stream is provided, and the heated vessel comprises a heating means which is suitable to maintain the vessel at a temperature between about 50 and 300° C. At least one condenser, which is situated in fluid communication with and downstream of the heated vessel, is provided. At least one dispensing means, which is situated in fluid communication with and downstream of the condenser is also provided. An outlet in fluid communication with the dispensing means is provided, where the outlet is suitable to deliver a stream of inorganic metallic precursor to at least one semiconductor processing tool.

Other embodiments of the current invention may include, with out limitation, one or more of the following features:
transforming at least part of the first stream by introducing the first stream into a heated vessel;
maintaining the operating temperature of the heated vessel between about 50 and 800° C.; and
maintaining the operating pressure of the heated vessel between about 0.01 and about 1000 torr;
providing a catalyst in the heated vessel to aid in transforming at least part of the ruthenium tetroxide into the solid phase lower ruthenium oxide;
the catalyst comprises ruthenium metal or ruthenium dioxide;
maintaining the operating temperature of the heated vessel between about 100 and 300° C.;
at least about 99%, and preferably about 99.9%, of the ruthenium oxide is reduced to the ruthenium metal through the reduction with hydrogen gas;
the ruthenium metal produced through the reduction with hydrogen has a specific surface area of greater than about 1.0 m²/g, and preferably of about 7.0 m²/g;
removing at least part of the ruthenium metal from the heated vessel after the reduction of the ruthenium oxide with hydrogen, and before contacting the ruthenium metal with the oxidizing mixture;
the oxidizing mixture comprises at least one member selected from the group consisting of NO, NO₂, O₂, O₃, mixtures thereof and plasma excited mixtures thereof;
purifying the second stream of ruthenium tetroxide of any oxidizing compounds through a distillation process;
obtaining ruthenium tetroxide with a purity greater than about 99.9%;
bubbling the high purity ruthenium tetroxide through a solvent to form a saturated mixture of solvent and high purity ruthenium tetroxide;
vaporizing the ruthenium tetroxide through a direct vaporization step;
producing the high purity ruthenium tetroxide without the introduction of sodium or a halogen containing compound;
a source of hydrogen situated in fluid communication with heated vessel is provided;
a source of an oxidizing mixture situated in fluid communication with the heated vessel is provided;
a second heated vessel, a condenser, and dispensing means all situated in parallel to the first vessel, condenser and dispensing means are provided;
a means to divert the incoming stream of inorganic metallic precursor between the first and second heated vessel is provided;
a catalyst disposed on the interior of the heated vessel, so that the stream of inorganic metallic precursor contacts the catalyst, is provided;
providing the high purity ruthenium tetroxide to the semiconductor processing tool contemporaneously to receiving the first gaseous stream.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a schematic representation of one embodiment of a process for recycling and purifying an inorganic metallic precursor;

FIG. 2 illustrates a schematic representation of another embodiment of a process for recycling and purifying an inorganic metallic precursor;

FIG. 3 illustrates empirical results according to one embodiment of the current invention;

FIG. 4 illustrates comparative empirical results to those shown in FIG. 3;

FIG. 5 illustrates empirical results according to one embodiment of the current invention; and

FIG. 6 illustrates empirical results according to one embodiment of the current invention.

### DESCRIPTION OF PREFERRED EMBODIMENTS

Generally, it is preferable from both an environmental and cost perspective, to be able to capture and reclaim materials used in the manufacture of semiconductor devices, as opposed to discarding them. When ruthenium is used in the manufacture of these devices, the processes normally require ruthenium be supplied in the form of ruthenium tetroxide. As these processes do not use all of the ruthenium tetroxide, it is therefore present (along with other byproducts) in the process waste products. It would be preferable to be able to capture the ruthenium tetroxide, and purify it so that it could be reused in the same or a different manufacturing process.

Generally, the current invention relates to methods to recycle and purify an inorganic metallic precursor comprises providing a first gaseous stream which comprises ruthenium tetroxide. At least part of the first stream is transformed into a solid phase lower ruthenium oxide. Ruthenium metal is then produced by transforming at least part of the lower ruthenium oxide into ruthenium metal through a reduction of the lower ruthenium oxide with hydrogen gas. The ruthenium metal is then contacted with an oxidizing mixture to produce a second stream comprising ruthenium tetroxide. This second stream is purified of any remaining oxidizing compounds to obtain a high purity ruthenium tetroxide. The current invention also relates to an apparatus for the recycling and purification of an inorganic metallic precursor used in the manufacture of semiconductor devices comprises an inlet to receive an incoming stream containing at least one inorganic metallic precursor. At least one heated suitable to receive the stream is provided, and the heated vessel comprises a heating means which is suitable to maintain the vessel at a temperature between about 50 and 300° C. At least one condenser, which is situated in fluid communication with and downstream of the heated vessel, is provided. At least one dispensing means, which is situated in fluid communication with and downstream of the condenser is also provided. An outlet in fluid communication with the dispensing means is provided, where the outlet is suitable to deliver a stream of inorganic metallic precursor to at least one semiconductor processing tool.

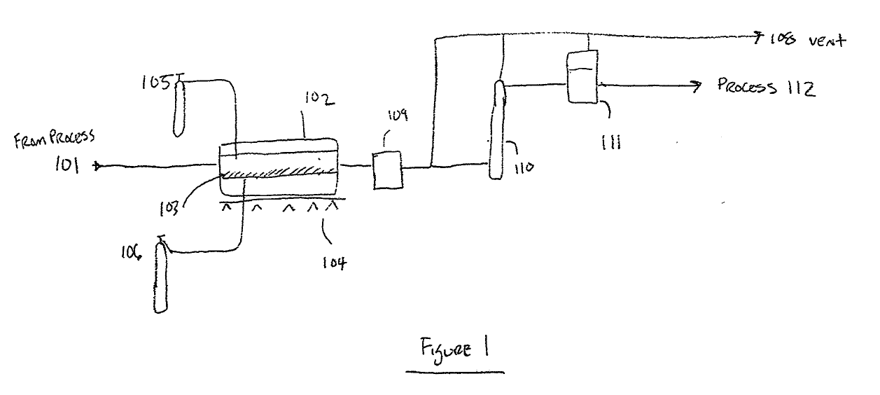

Referring now to FIG. 1, non-limiting embodiments of the method and apparatus according to the current invention are described hereafter. An precursor recycling and purification system 100 is shown. A first stream of inorganic metallic precursor 101, which comprises ruthenium tetroxide is provided. This stream may be waste product or excess product from a semiconductor deposition process, such as a chemical vapor deposition (CVD) or an atomic layer deposition (ALD) process. First stream 101 may be sent to a heated vessel 102, which has an inlet, and outlet, and at least one interior surface 103 suitable for a solid precursor to be collected on. Heated vessel 102 may also comprise a heating means 104 which is suitable to maintain the temperature of vessel 102 at a temperature between about 50 and 800° C., and preferably between about 100 and 300° C.

In some embodiments, heated vessel 102 may be a conventional type metallic reactor vessel as would be known by one of skill in the art. Heated vessel 102 may be constructed so as to be suitable to maintain an internal pressure between about 0.01 torr and about 1000 torr. Likewise, in some embodiments the heating means 104 may be a conventional heating means such as a resistance or direct contact heater which supplies heat to a wall of the heated vessel.

In some embodiments, heated vessel 102 is in fluid communication with a source of hydrogen 105 and a source of an oxidizing mixture 106. Hydrogen source 105 and oxidizing mixture 106 may both be conventional sources of supply, such as cylinders of gas, or connections to other exiting supply lines or supply systems. In some embodiments, the oxidizing mixture 106 may be a mixture of NO, NO₂, O₂, O₃, or mixtures thereof.

When the first stream 101 enters heated vessel 102, ruthenium tetroxide contained within the first stream 101 decomposes to form a solid lower ruthenium oxide (e.g ruthenium dioxide) through the addition of heat according to a standard decomposition reaction, as generally illustrated below:

RuO₄+heat→RuO₂+O₂.

In some embodiments the amount of heat required by this reaction may be between about 100 and 300° C., and preferably about 210° C. Any by products of the decomposition reaction other than the lower ruthenium (e.g. oxygen) may be sent out of the heated vessel 102 and to vent 108. The lower ruthenium produced may form on the interior surface 103 of the heated vessel 102.

In some embodiments, a catalyst may be added to the heated vessel 102 to aid in the transformation of the ruthenium tetroxide into the lower ruthenium oxide. This catalyst may be mechanically added to at least one interior surface 103 of heated vessel 102 in a conventional manner, for instance, through an access panel (not shown) in the heated vessel 102. In some embodiments, the catalyst may be ruthenium metal or ruthenium dioxide.

This lower ruthenium which is located on an interior surface 103 of the heated vessel may then be transformed into ruthenium metal through the introduction of hydrogen gas 105 into the heated vessel 102. The hydrogen gas 105, which is introduced in an amount less than its lower explosion limit (e.g. 4% by vol), reduces the ruthenium oxide to a ruthenium metal through a standard reduction reaction, as generally illustrated below:

RuO₂+2H₂→Ru+2H₂O.

As no compounds other than hydrogen are used, the yield of this reduction can be very high, for instance greater than about 99% yield, and preferably, greater than about 99.9% yield rate. Any by products of the reaction, other than the ruthenium metal (e.g. hydrogen, oxygen, or water vapor) may be sent out of the heated vessel 102 and to vent 108.

It has been determined that ruthenium metal produced in this manner, has at least one advantageous property in that it has a high specific surface area. For instance, the specific surface area of ruthenium metal produced according to some embodiments of the current invention is greater than about 1.0 m²/g, and preferably about 7.0 m²/g.

In some embodiments, at least a part of the ruthenium metal may be removed from the heated vessel 102 after the reduction of the ruthenium oxide with hydrogen, and before contacting the ruthenium metal with the oxidizing mixture. Removal of the ruthenium metal can be done in a conventional manner, for instance, by mechanically removing part of the metal from the heated vessel 102 through an access panel (not shown). The ruthenium metal may then be used in numerous other processes, for instance, it may be used in the synthesis of another precursor (e.g. RuCl₃).

After the ruthenium metal is produced, it is then contacted with the oxidizing mixture 106, to produce ruthenium tetroxide. In an embodiment where the oxidizing mixture is ozone, the production of ruthenium tetroxide occurs as generally illustrated below:

3Ru+4O₃+3RuO₄.

In these embodiments, as the oxidizing mixture 106 is flown over the ruthenium metal, the ruthenium tetroxide is entrained in the gas flow. The amount of ruthenium tetroxide contained in the gas flow may be determined through monitoring with an analyzer 109, located downstream of the heated vessel 102. Analyzer 109 may be a conventional type of analyzer, as known to one of skill in the art, for example analyzer 109 may be a UV spectrometer.

It has been determined that ruthenium tetroxide produced according to at least one embodiment of the current invention, has at least one advantageous property in that the rate of formation of ruthenium tetroxide is very rapid. As the ruthenium metal has been produced with a high yield, there is little to no ruthenium oxide layer present on the metal which would impede the ruthenium metal's reaction with the oxidizing mixture in the formation ruthenium tetroxide. This provides for a fast and efficient production of ruthenium tetroxide from the ruthenium metal.

After the ruthenium tetroxide entrained in the gas flow is produced, the ruthenium tetroxide is then purified of any remaining oxidizing compounds to produce a high purity ruthenium tetroxide. In some embodiments, the high purity ruthenium tetroxide is produced by separating the oxidizing compounds through a cold distillation type process. For example, the ruthenium tetroxide may be separated from the oxidizing compounds by sending the mixture to a cold distillation column 110 where the temperature is such that the ruthenium tetroxide condenses and collects, while the oxidizing compounds (e.g. ozone or oxygen) which have low boiling points, do not and pass through the cold distillation column 110 and are sent to vent 108. In some embodiments, this process produces a purified ruthenium tetroxide with a purity of greater than or equal to about 99.9%.

After the ruthenium tetroxide is separated from the oxidizing compounds, it may be sent to a dispensing means 111, which prepares the ruthenium tetroxide for distribution to the semiconductor manufacturing process 112. In some embodiments, the purified ruthenium tetroxide can be used directly in a semiconductor manufacturing process (e.g. a CVD or ALD deposition) 112, such that dispensing means 111 may be a flow controller that regulates the amount of ruthenium tetroxide dispensed to the process 112. In some embodiments, the purified ruthenium tetroxide may first be bubbled through a solvent before being provided to the manufacturing process 112. In these embodiments, the purified ruthenium tetroxide may be sent from the distillation column 110 to dispensing means 111, where it may be bubbled into a solvent (e.g. HFE-7500, HFE 7100, HFE, 7200 or mixtures thereof, all commercially available from the 3M Company) prior to being provided to the manufacturing process. Dispensing means 111 may be a conventional type bubbler as known to one of skill in the art. In some embodiments, dispensing means 111 may be a direct vaporization type system where the ruthenium tetroxide may be introduced to the manufacturing process 112 through a direct vaporization step. Such a direct vaporization system is known in the art, and may include a liquid mass flow controller and a vaporizer, such as a glass or metal tube. Inert gas (e.g. nitrogen, argon, helium, etc) may be used to pressurize the ruthenium tetroxide, and cause it to flow from a storage vessel, through a liquid flow controller, and into the vaporizer. If inert gas is not used to cause the liquid to flow, a vacuum (or lower pressure condition) may be generated downstream of the precursor storage vessel, for instance, at the vaporizer outlet.

With respect to the embodiments of the current invention described above, it is known that various other elements, such as valves and flow controllers, may be incorporated into the system as necessary. For instance, all elements described above (e.g. heated vessel 102, distillation column 110, dispensing means 111) may have valves disposed upstream and downstream, as is known to one of skill in the art. Likewise, various flow controllers may be incorporated to control and modify the flow rate of the various gases employed according to embodiments of the current invention. For expediency sake, these elements have not been shown on FIG. 1, but nonetheless are considered to be incorporated into the various embodiments of the current invention.

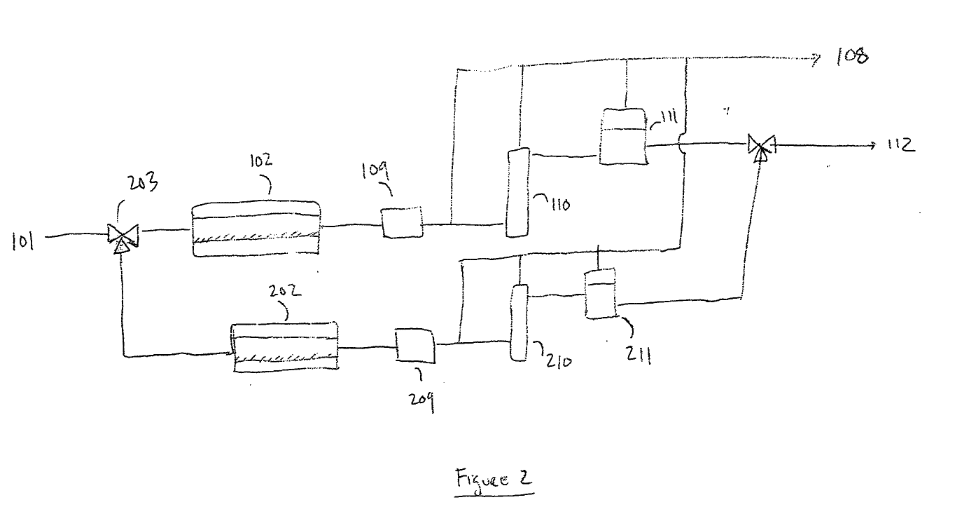

Referring now to FIG. 2, a non-limiting embodiment of an apparatus according to the current invention is described hereafter. In this embodiment, the apparatus described in FIG. 1 is generally provided (with like numbers showing similar elements). A second set of components (e.g. a second heated vessel 202, a second analyzer 209, a second distillation column 210 and a second dispensing means 211) are provided in a parallel configuration to the first heated vessel 102, the first analyzer, the first distillation column 110 and the first dispensing means 111 (e.g. the first set of components). Additionally a means to divert 203 the incoming stream of inorganic metallic precursor between the first heated vessel 102, and the second heated vessel 202 is provided. In some embodiments, this diverting means 203 may be a conventional type three way valve. In this embodiment, it is possible to provide purified ruthenium tetroxide to the semiconductor tool (e.g. manufacturing process) 112 continuously, as the parallel configuration allows delivery from one set of components, while the other set of components are either recycling or purifying. Stated another way, the parallel configuration allows for the contemporaneous receiving of the first gaseous stream 101 with the delivery of the purified ruthenium tetroxide to the semiconductor tool (e.g. manufacturing process) 112.

While the foregoing describes the present invention in terms of methods and apparatus for recycling and purification of inorganic metallic precursors (e.g. ruthenium tetroxide), the present invention may also be applied towards precursor compounds comprising osmium.

### EXAMPLES

The following non-limiting examples are provided to further illustrate embodiments of the invention. However, the examples are not intended to be all inclusive and are not intended to limit the scope of the inventions described herein.

### Example 1

Commercially available ruthenium (ruthenium powder under 200 micron mesh, obtained from the Sigma-Aldrich company) and ruthenium which was recycled according to an embodiment of the current invention were compared. Both samples were dried prior to the analysis in an N2/He atmosphere for 2 hours at 120° C., and the specific surface area of each was examined through a BET analysis. The recycled ruthenium exhibited a specific surface area 18 times higher then that commercially obtained.

| Material | Specific Surface area |
|---|---|
| Commercially available Ruthenium | 0.4 m²/g |
| Recycled Ruthenium | 7.1 m²/g |

### Example 2

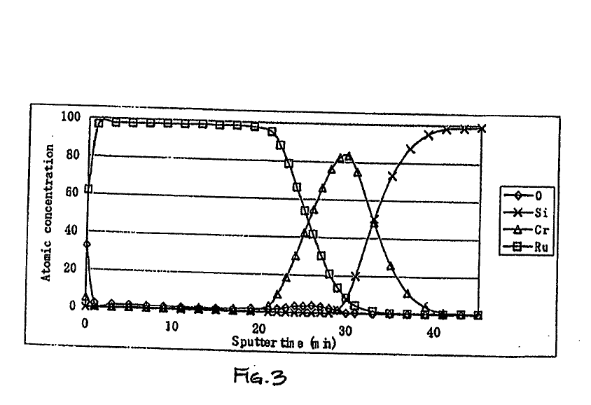

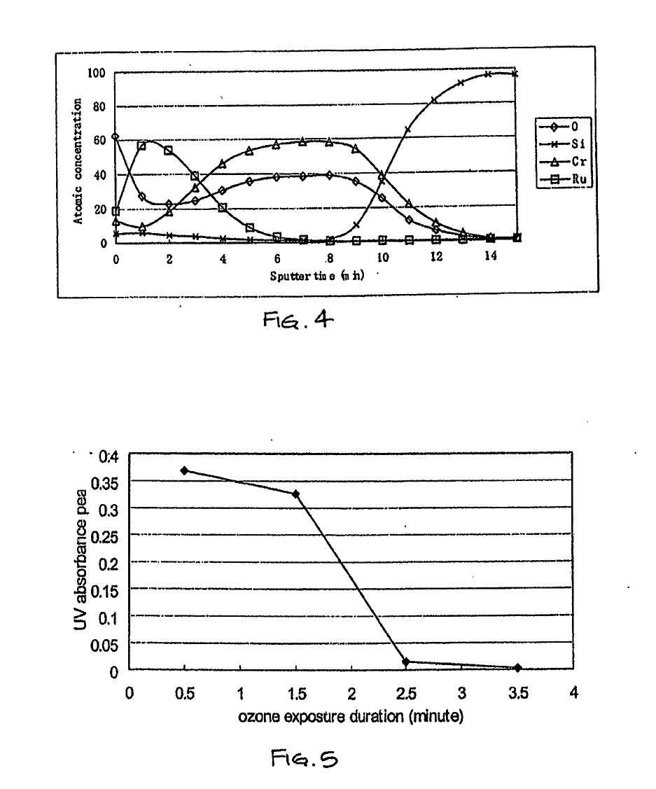

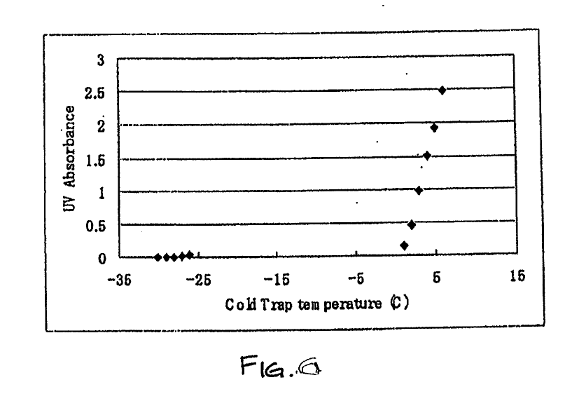

The efficiency of the hydrogen reduction was examined by the difference in the cleaning capacity of ozone on two sputtered samples of ruthenium, one which had been reduced with hydrogen (“treated”), and one which had not (“untreated”). 2 samples of about 1000 A of ruthenium were deposited on a chromium layer (adhesion layer). The treated sample was first treated through a reduction reaction with hydrogen (4% H₂ in nitrogen) at atmospheric pressure and at a temperature of about 200° C. This treatment lasted approximately 5 minutes. No such treatment was performed on the untreated sample. Both samples were then exposed to a flow of ozone (5% ozone/oxygen). An auger in depth analysis was then performed on both samples. FIG. 3 shows the results from the treated sample, while FIG. 4 shows the results of the untreated sample. FIG. 5 also shows the response time for the treated sample in the production of ruthenium tetroxide, after the flow of oxidizing (ozone) mixture was started.

### Example 3

Tests were conducted with a distillation column/cold trap to separate ruthenium tetroxide from residual oxidizing compounds generated according to embodiments of the current invention. A cold trap was provided whose temperature was set at −30° C., and a ruthenium tetroxide/ozone mixture was flown through the trap. In the instant example, propanol was mixed with liquid nitrogen to provide the low temperature. As the mixture was flown through the trap (which in this case was glass) a characteristic color change to yellow could be observed as the ruthenium tetroxide was collected. Due to the low boiling point of ozone and oxygen (−112° C. and −183° C. respectively), none of these molecules were trapped in the cooling device, thus assuring a high purification of the ruthenium tetroxide. The delivery of ruthenium tetroxide was then examined by UV spectrometer, and the generation of ruthenium tetroxide as a function of temperature was monitored. FIG. 6 shows how the flow of delivered ruthenium tetroxide can be controlled by accurately setting the appropriate temperature in the distillation column/cold trap.

While embodiments of this invention have been shown and described, modifications thereof can be made by one skilled in the art without departing from the spirit or teaching of this invention. The embodiments described herein are exemplary only and not limiting. Many variations and modifications of the composition and method are possible and within the scope of the invention. Accordingly the scope of protection is not limited to the embodiments described herein, but is only limited by the claims which follow, the scope of which shall include all equivalents of the subject matter of the claims.

What is claimed is:

1. A method to recycle and purify an inorganic metallic precursor, comprising:
a) providing a first gaseous stream comprising ruthenium tetroxide;
b) transforming at least part of the first stream of ruthenium tetroxide into a solid phase lower ruthenium oxide;
c) producing ruthenium metal by transforming at least part of the ruthenium oxide into ruthenium metal through a reduction of the ruthenium oxide with hydrogen;
d) contacting the ruthenium metal with an oxidizing mixture to produce a second stream comprising ruthenium tetroxide; and
e) purifying the second stream of ruthenium tetroxide of any oxidizing compounds to obtain high purity ruthenium tetroxide.

2. The method of claim 1, further comprising:
a) transforming at least part of the first stream by introducing the first stream into a heated vessel;
b) maintaining the operating temperature of the heated vessel between about 50 and 800° C.; and
c) maintaining the operating pressure of the heated vessel between about 0.01 and about 1000 torr.

3. The method of claim 2, further comprising providing a catalyst in the heated vessel to aid in transforming at least part of the ruthenium tetroxide into the solid phase lower ruthenium oxide.

4. The method of claim 3, wherein the catalyst comprises ruthenium metal or ruthenium dioxide.

5. The method of claim 2, further comprising maintaining the operating temperature of the heated vessel between about 100 and 300° C.

6. The method of claim 1, wherein at least about 99% of the ruthenium oxide is reduced to the ruthenium metal through the reduction with hydrogen.

7. The method of claim 6, wherein at least about 99.9% of the ruthenium oxide is reduced to the ruthenium metal through the reduction with hydrogen.

8. The method of claim 1, wherein the ruthenium metal produced through the reduction with hydrogen has a specific surface area of greater than about 1.0 m²/g.

9. The method of claim 1, wherein the ruthenium metal produced through the reduction with hydrogen has a specific surface area of about 7.0 m²/g.

10. The method of claim 1, further comprising removing at least part of the ruthenium metal from the heated vessel after the reduction of the ruthenium oxide with hydrogen, and before contacting the ruthenium metal with the oxidizing mixture.

11. The method of claim 1, wherein the oxidizing mixture comprises at least one member selected from the group consisting of:
a) NO;
b) NO₂;
c) O₂;
d) O₃;
e) mixtures thereof; and
f) plasma excited versions thereof.

12. The method of claim 1, further comprising:
a) purifying the second stream of ruthenium tetroxide of any oxidizing compounds through a distillation process; and
b) obtaining ruthenium tetroxide with a purity greater than about 99.9%.

13. The method of claim 1, further comprising bubbling the high purity ruthenium tetroxide through a solvent to form a saturated mixture of solvent and high purity ruthenium tetroxide.

14. The method of claim 1, further comprising vaporizing the ruthenium tetroxide through a direct vaporization step.

15. The method of claim 1, further comprising producing the high purity ruthenium tetroxide without the introduction of sodium or a halogen containing compound in any of the steps (a)-(e).

16. An apparatus for the recycling and purification of a stream of inorganic metallic precursor used in the manufacture of semiconductor devices, comprising:
a) an inlet to receive an incoming stream of inorganic metallic precursor;
b) at least one first heated vessel suitable to receive the stream of inorganic metallic precursor, wherein the heated vessel comprises a heating means suitable to heat the vessel to a temperature between about 50 and 300° C.;
c) at least one condenser situated in fluid communication with and downstream of the heated vessel;
d) at least one dispensing means situated in fluid communication with and downstream of the condenser; and
e) an outlet in fluid communication with the dispensing means to deliver a stream of inorganic metallic precursor to at least one semiconductor processing tool.

17. The apparatus of claim 16, further comprising:
a) a source of hydrogen situated in fluid communication with heated vessel; and
b) a source of an oxidizing mixture situated in fluid communication with the heated vessel.

18. The apparatus of claim 16, further comprising:
a) a second heated vessel, a condenser, and dispensing means all situated in parallel to the first vessel, condenser and dispensing means; and
b) a means to divert the incoming stream of inorganic metallic precursor between the first and second heated vessel.

19. The apparatus of claim 16, further comprising a catalyst disposed on the interior of the heated vessel, so that the stream of inorganic metallic precursor contacts the catalyst.

20. The apparatus of claim 16, wherein the stream of inorganic precursor delivered to the semiconductor processing tool comprises at least about 99.9% ruthenium tetroxide.

21. A method to recycle and purify an inorganic metallic precursor received from a semiconductor processing tool, comprising:
a) receiving a first gaseous stream comprising ruthenium tetroxide from the output of a semiconductor manufacturing process;
b) transforming at least part of the first stream of ruthenium tetroxide into a solid phase lower ruthenium oxide, by heating the first stream in a heated vessel maintained at a temperature between about 50 and 300° C.;
c) producing ruthenium metal by transforming at least part of the ruthenium oxide into ruthenium metal through a reduction of the ruthenium oxide with hydrogen;
d) contacting the ruthenium metal with an oxidizing mixture to produce a second stream comprising ruthenium tetroxide; and
e) purifying the second stream of ruthenium tetroxide of any oxidizing compounds to obtain high purity ruthenium tetroxide, wherein the high purity ruthenium tetroxide has a purity of about 99.9%; and
f) providing the high purity ruthenium tetroxide to a semiconductor processing tool for use in a deposition process.

22. The method of claim 19, further comprising providing the high purity ruthenium tetroxide to the semiconductor processing tool contemporaneously to receiving the first gaseous stream.
